(19) United States
(12) Patent Application Publication
(10) Pub. No.: US 2008/0079936 A1
(43) Pub. Date: Apr. 3, 2008

(54) Internal thread inspection probe

(75) Inventors: Christopher A. Kinney, Iuka, MS (US); Marvin B. Klein, Pacific Palisades, CA (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 11/529,494

(22) Filed: Sep. 29, 2006

(51) Int. Cl. G01N 21/00

(52) U.S. Cl. 356/241.1; 356/237.1

(57) ABSTRACT

An apparatus is provided for detecting flaws in a threaded bore having at least one thread with a helical root is provided. The apparatus may include a thread engagement member configured to engage the at least one thread of the threaded bore. The apparatus may also include a probe coupled with the thread engagement member. The probe may be configured to direct light onto the helical root of the threaded bore. The probe and the thread engagement member may be adapted to rotate relative to the bore while the probe continually directs light onto the helical thread so that the light sweeps along a section of the helical root.

### TECHNICAL FIELD

This disclosure relates generally to a method and apparatus for determining physical characteristics of an object surface, and, more particularly, for inspecting and determining presence of a surface flaw.

### BACKGROUND

Some machinery of internal combustion engines may be utilized as remanufactured components. Usually, these components may be removed from the original equipment, cleaned, inspected, treated, if necessary, and sold as remanufactured units. Remanufactured parts provide lower cost options to buyers of such parts.

Some of these engine components, such as connecting rods, for example, may contain threaded bores. During operational use, surface flaws, such as cracks, may develop within the roots of the threads. Such cracks can propagate and cause fatigue and possible failure of the component, including, for example, a break in the body of the connecting rod.

U.S. Pat. No. 5,004,339 issued to Pryor et al. discloses a method and apparatus for determining physical characteristics of objects and object surfaces. Light or other electromagnetic radiation is directed onto a first portion of a surface. The radiation reflected from the first portion is compared with the radiation reflected from two other portions proximate to the first portion. The radiation and comparison steps are repeated, and the comparisons are used to determine a physical characteristic of the surface, such as the presence of one or more flaws. This method may be effective for relatively simple surfaces such as flat surfaces. For more complex surfaces, such as threaded surfaces, Pryor et al. may not be able to provide adequate detection of flaws. This may be due, in part, to the inability of Pryor et al. to distinguish between detecting a flaw or merely a type of surface structure such as a root of a thread, a peak of a thread, or a flank area. One might also question the reliability of what Pryor et al. considers to be a good signal since different types of surface structures may yield variances in reflected light or other electromagnetic radiation during the comparison process for determining the physical characteristic of the surface. Hence, while Pryor purports to be able to obtain the number of threads and their pitch along a threaded surface, the accuracy with which Pryor et al. determines whether one or more flaws exist, or the location of such flaws, may be questionable. Thus, some flaws, such as those located in the root of threaded bores, may not be detected. Undetected flaws may cause failure in the structure of one or more components.

The present disclosure is directed towards overcoming one or more shortcomings set forth above.

### SUMMARY OF THE INVENTION

In accordance with one disclosed exemplary embodiment, an apparatus for detecting flaws in a threaded bore having at least one thread with a helical root is provided. The apparatus may include a thread engagement member configured to engage the at least one thread of the threaded bore. The apparatus may also include a probe coupled with the thread engagement member. The probe may be configured to direct light onto the helical root of the threaded bore. The probe and the thread engagement member may be adapted to rotate relative to the bore while the probe continually directs light onto the helical thread so that the light sweeps along a section of the helical root.

In accordance with another disclosed exemplary embodiment, a method for detecting flaws in a threaded bore may include providing a shaft configured to transmit laser or incoherent light and inserting the shaft into the threaded bore. Laser or incoherent light may be transmitted into the shaft. The shaft may be aligned to project the laser or incoherent light onto a spot disposed on a circumferential surface of the threaded bore. The laser or incoherent light may be redirecting and projected onto the spot. A reflectance of the laser or incoherent light may be received from the circumferential surface of the threaded bore into the shaft. The method may also include detecting a characteristic of the reflected laser or incoherent light.

In accordance with another disclosed exemplary embodiment, a method for detecting flaws in a threaded bore having at least one thread with a helical root is provided. The method may include directing light onto a point on the helical root. The point may be moved along the length of a section of the helical root. A reflectance of the light may be received back. The method may also include determining whether a flaw is present based, at least, in part upon the reflected light.

### BRIEF DESCRIPTION OF THE DRAWINGS

FIG. 1 provides a diagrammatic view of an optical subsystem according to an exemplary disclosed embodiment;

FIG. 2 provides an exploded view of the probe of FIG. 1 in relation to a threaded bore according to an exemplary disclosed embodiment.

FIG. 3 provides a diagrammatic perspective view of a tool according to an exemplary disclosed embodiment;

FIG. 4 provides a rotated perspective view of the tool of FIG. 3;

FIG. 5 provides a detail view of the shaft assembly of the tool of FIGS. 3 and 4;

FIG. 6 provides a diagrammatic view of the shaft assembly of FIG. 5 in connection with components of the housing assembly and handle of FIGS. 3 and 4; and

FIG. 7 provides a cross-sectional view of the tool of FIGS. 3 and 4.

### DETAILED DESCRIPTION

Referring to the figures, an exemplary optical subsystem 2 is illustrated having multiple components for inspecting and determining flaws on surfaces, such as cracks, for example, in a threaded bore. In one embodiment, components of the optical subsystem 2 may include a laser or incoherent light source 8 and a surface inspection device 4. A beam splitter assembly 6 may be coupled between the surface inspection device 4 and the laser or incoherent light source 8. In one disclosed embodiment, a fiber optic cable 17A may be utilized to couple the beam splitter assembly 6 to the incoherent light source 8. Likewise, another fiber optic cable 17B may be utilized to couple the beam splitter assembly 6 to the surface inspection device 4. The surface inspection device 4 may include a rotary optical joint 20 which may be configured to connect with one end of the fiber optic cable 17B. Another fiber optic cable 17C may be connected from the rotary optical joint 20 to a probing device 15. The rotary optical joint 20 may facilitate infinite rotation of the fiber optic cable 17C connected to the probing device 15. Other cables or connectors suitable for transferring laser or incoherent light may be utilized to couple the beam splitter assembly 6 to the surface inspection device 4 and the laser or incoherent light source 8.

Hence, the laser or incoherent light source 8 may supply a laser or incoherent light beam to the beam splitter assembly 6. At least a portion of the laser or incoherent light may pass through the beam splitter assembly 6 and enter the surface inspection device 4, such as via the rotary optical joint 20, and be supplied to the probing device 15. The probing device 15 may be configured to receive the laser or incoherent light and deflect the laser or incoherent light as an optical beam 23 onto a surface of an object.

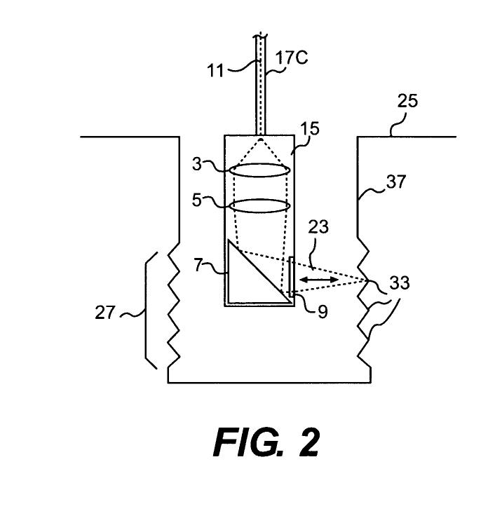

For example, FIG. 2 illustrates a probing device 15 inserted within an interior 37 of a threaded bore 25. Laser or incoherent light 11 may be supplied via fiber optic cable 17C into the probing device 15. The probing device 15 may include a beam forming telescope having, for example, two lenses. The lenses may include a collimating lens 3 and a focusing lens 5 for facilitating focusing the laser or incoherent light 11 at a prescribed size and location.

The probing device 15 may also include a prism 7. The telescope may direct the laser or incoherent light 11 onto the prism 7. The prism 7 may redirect the laser or incoherent light 11 to a prescribed location point. In the disclosed embodiment, the prism 7 may include a 90° turning prism which may receive and redirect the laser or incoherent light 11, for example, at 90° from a longitudinal axis of the probing device 15. The redirected laser or incoherent light 11 may be projected through a window 9 of the probing device 15 as an optical beam 23. The window 9 may also prevent foreign articles, such as dust, from entering the probing device 15. The optical beam 23 may be focused to a point having a prescribed size and location such as in the root 33 of one or more threads 27. Hence, the aforementioned size may include a spot having a dimension which may fall within the dimension of one or more threads 27.

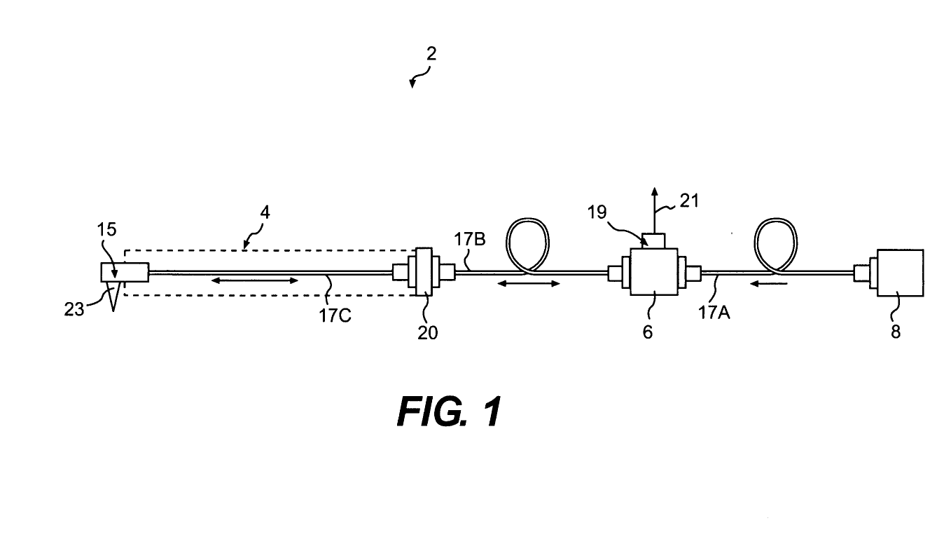

Once an amount of laser or incoherent light is projected, for example, as an optical beam 23 onto a surface of an object, an amount of reflected light may be received back into the probing device 15. The prism 7 may redirect the reflected light back towards the telescope. The telescope may facilitate alignment of the reflected light back into the fiber optic cable 17C. Hence, turning, again, to FIG. 1, the reflected optical beam 23 may be transmitted from the probing device 15 through the fiber optic cable 17C and the rotary optical joint 20. The reflected optical beam 23 may be further transmitted through the fiber optic cable 17B into the beam splitter assembly 6. A photodetector 19 may be configured to receive at least a portion of the reflected optical beam 23 from the beam splitter assembly 6. The photodetector 19 may measure the power of the reflected optical beam 23. The measured power may be converted to an electrical output signal 21. The electrical output signal 21 may quantify a reflected energy change of the reflected optical beam 23 as described below.

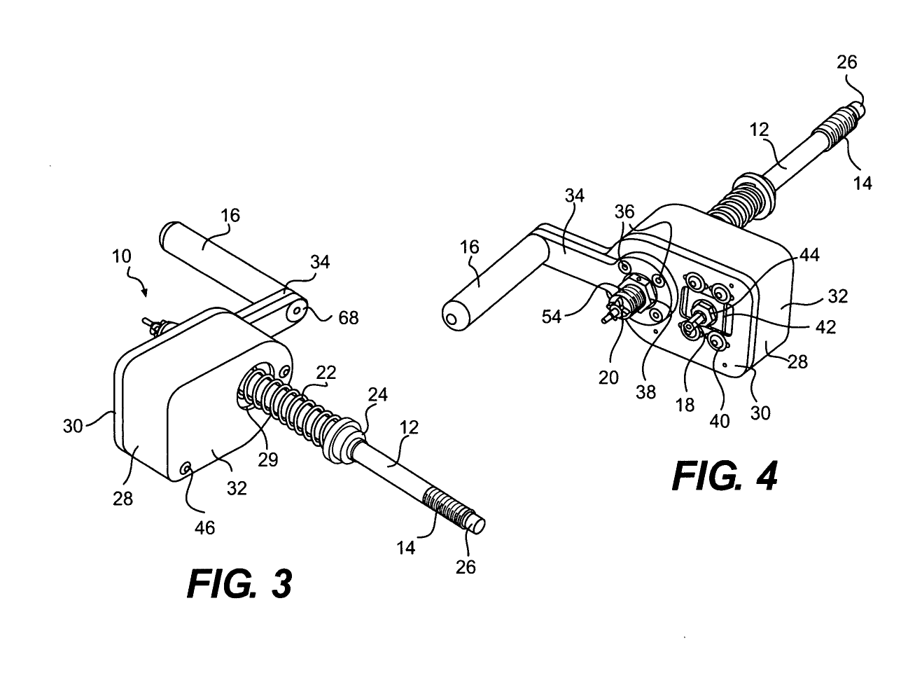

FIGS. 1 and 2 provide a schematic illustration of a disclosed embodiment for inspecting and determining the presence of a surface flaw. In one embodiment, the surface inspection device 4 may include a computer numerically controlled (CNC) machine configured to manipulate a position of the probing device 15 such as along directions including the X, Y, and Z-axis of the interior 37. FIG. 3 provides another embodiment of a surface inspection device 4 which may be utilized by the disclosed embodiment. The surface inspection device 4 may include a tool 10 for identifying cracks, such as those disposed in a threaded hole. The tool 10 may include a housing assembly 28 for retaining and protecting components of the tool 10. In one embodiment, the housing assembly 28 may include an upper housing assembly 30 and a lower housing assembly 32. A handle 16 used, for example, for transporting or locating the tool 10 into position may be coupled to the housing assembly 28.

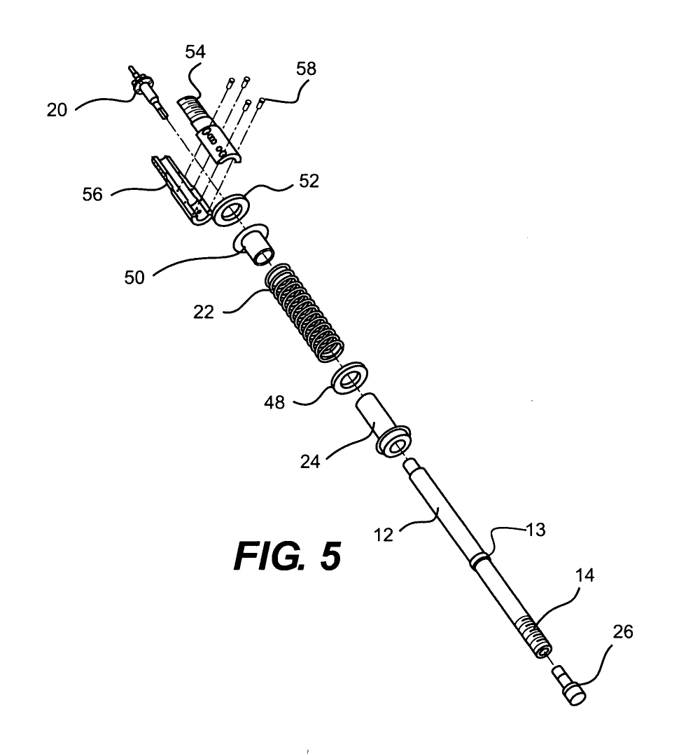

Turning to FIG. 4, a handle mount plate 34 may be disposed on the upper housing assembly 30. A fastener 68 (FIG. 3) may be utilized to retain the handle 16 to the handle mount plate 34. A plurality of fasteners 36 may be used to secure the handle mount plate 34 to the upper housing assembly 30.

A probe 26 may be used to facilitate identification of one or more flaws, such as fatigue cracks on internal surfaces of a threaded bore. Probe 26 of tool 10 may correspond to the probing device 15 of the surface inspection device 4. Moreover, the probe 26 may function in the same capacity as the probing device 15 of the surface inspection device 4. Hence, the probe 26 may be configured to receive laser or incoherent light emitted from a laser or incoherent light source 8 (e.g., FIG. 1). As with the probing device 15, probe 26 may also contain components, such as a telescope, having a collimating lens 3 and a focusing lens 5, and prism 7, for focusing and deflecting the laser or incoherent light onto a surface of an object. The probe 26 may also be configured to receive reflected laser or incoherent light from the surface of an object. As detailed below, a reflectance measuring device may be coupled to the tool 10 to measure an amount of energy reflected received from the probe 26 such as from an internal surface, including, for example, the root of a threaded bore. In one disclosed embodiment, the telescope and prism may be configured to receive laser or incoherent light and deflect it onto a surface at 90 degrees from a longitudinal axis of the probe 26. In one disclosed embodiment, the probe 26 may also be secured to one end of a shaft 12.

Turning to FIG. 5, the disclosed embodiment depicts shaft 12 having threads 14 at one end and a stop member 13 along a portion thereof. The shaft 12 may be inserted into a plurality of assembled components. For example, a lower spring pad 24 may be inserted over an end of the shaft 12 and abut against the stop member 13. A thrust bearing 48 may be inserted over an end of the lower spring pad 24. Spring 22 may be fitted over a portion of the lower spring pad 24. A portion of an upper spring pad 50 may be inserted and fitted against another end of the spring 22. Thrust bearing 52 may be fitted against the upper spring pad 50. A rotary optical joint 20 may be fitted to an end of the shaft 12. A split housing assembly 56 may encapsulate a portion of the rotary optical joint 20. Fasteners 58 may be used to secure the split housing assembly 56 together. The split housing assembly 56 may also include threads 54 for receiving a bearing lock nut 38 as shown, for example, in FIG. 4. The bearing lock nut 38 may not only facilitate retaining the rotary optical joint 20 to the shaft 12, but also couple the shaft 12 to the housing assembly 28 of the tool 10.

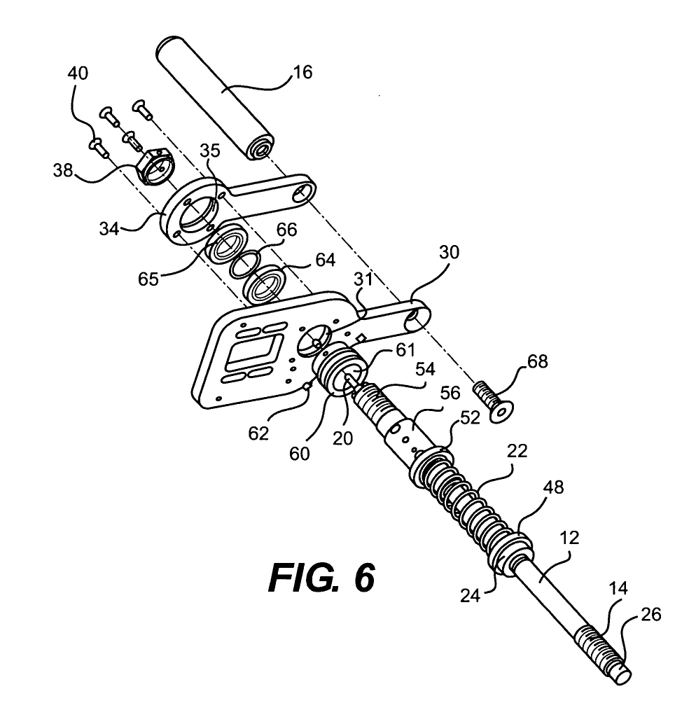

FIG. 6 illustrates additional details of the shaft assembly in connection with components of the housing assembly 28. The split housing assembly 56 may be received through an opening 61 in pulley 60. The pulley 60 may be secured to the split housing assembly 56 and be retained thereon, such as by set screws 62. Hence, rotation of the pulley 60 may cause rotation of the shaft 12.

The threads 54 of the split housing assembly 56 may extend through an opening 31 of the upper housing assembly 30. The threads 54 may also be inserted through a ball bearing assembly 64, a spacer 66, a ball bearing assembly 65, and an opening 35 of the handle mount plate 34. Again, bearing lock nut 38 may be threaded upon corresponding threads 54 of the split housing assembly 56. Appropriate tightening of the bearing lock nut 38 may retain the handle mount plate 34, the upper housing assembly 30, and the components on the shaft 12 together in a secure arrangement. As shown in FIG. 3, the end of shaft 12 having the attached probe 26 may extend through an opening 29 of the lower housing assembly 32. The lower housing assembly 32 may be attached to the upper housing assembly 30 using one or more fasteners 46 to form the completed housing assembly 28.

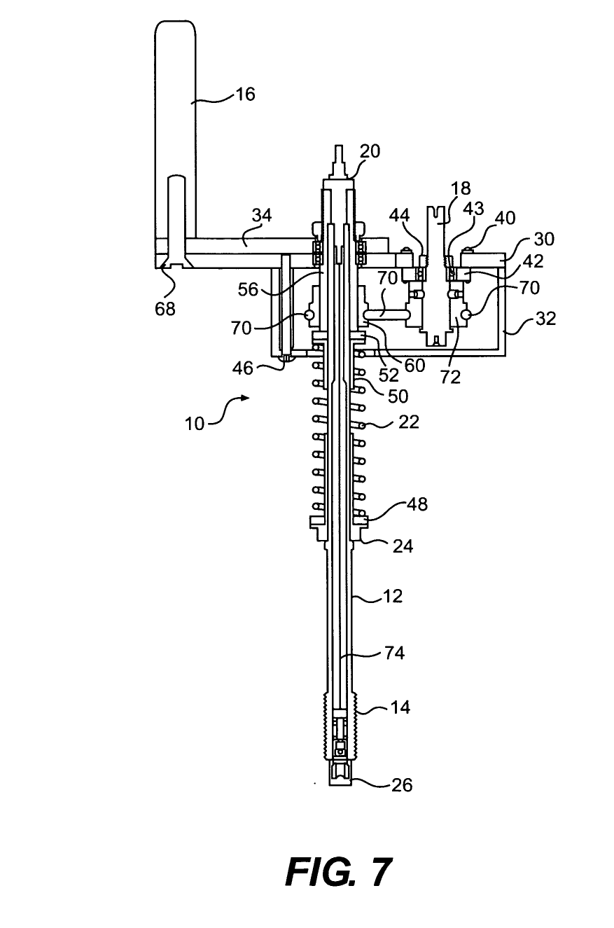

Returning to FIG. 4, a drive unit 18 is shown connected to a support body 42. A bearing lock nut 44 may be threaded onto a portion of the drive unit 18 to retain it to the support body 42. The support body 42 may be mounted to the upper housing assembly 30 using one or more fasteners 40. As shown in FIG. 7, a ball bearing assembly 43 may be fitted between the support body 42 and the drive unit 18 in order to allow rotation of the drive unit 18. A drive pulley unit 72 may be connected to the drive unit 18. A drive belt 70 may couple pulley 60 to drive pulley unit 72. Hence, rotation of the drive unit 18 may cause rotation of the shaft 12 via connection of the drive belt 70 coupling the pulley 60 to the drive pulley unit 72. The drive unit 18 may be driven by a variety of means, including, for example, an electrically driven motor, or any other appropriate drive mechanism connected thereto. A fiber optic cable 74 may be coupled between the rotary optical joint 20 and the probe 26. The rotary optical joint 20 may provide infinite rotation of the fiber optical cable 74 connected thereto, as the shaft 12 is rotated by drive unit 18.

### INDUSTRIAL APPLICABILITY

The disclosed surface inspection device 4 may have applicability in any system, for example, requiring inspection and detection of flaws on surface structures. These surface structures may include cracks, for example, in the internal surface of a threaded bore. In operation, laser or incoherent light from the laser or incoherent light source 8 may be provided to the probing device 15 of the surface inspection device 4. The probing device 15 may emit the laser or incoherent light as an optical beam 23 focused to a point, for example, onto a surface of an object. In one disclosed embodiment, the optical beam 23 is emitted at approximately 90 degrees from a surface of the probing device 15 onto a surface of the object. The aforementioned surface of the object may include threads 27 of a threaded bore 25.

In order to increase the probability of detecting existing flaws on the surface of threads 27, it is desirable to project the optical beam 23 directly into the root 33 of the threads 27. This may require making an adjustment of the optical beam 23 with respect to the threads 27. Hence, it may be necessary to adjust a position of the probing device 15 to accurately align the optical beam 23 in the root 33 of the threads 27.

In one disclosed embodiment, the surface inspection device 4 may include a CNC machine. The CNC machine may manipulate a position of the probing device 15 to be adjusted in directions, for example, along the X-axis, Y-axis, and Z-axis. Hence, a position of the probing device 15 may be adjusted along a vertical axis of the interior 37 of the threaded bore 25. This may include aligning the optical beam 23 emitted from the probing device 15 with the root 33 of the threads 27 of the threaded bore 25. Moreover, the optical beam 23 may be swept along the threads in a rotary fashion by rotating the probing device 15 via the CNC machine such as along the Z-axis.

As previously discussed, the probing device 15 may also be configured to receive a reflectance of the optical beam 23 such as from the surface of the interior 37 of the threaded bore 25. The reflected optical beam 23 may be transmitted from the probing device 15 back to the beam splitter assembly 6. A photodetector 19 (e.g., coupled to the beam splitter assembly 6) may receive at least a portion of the reflected optical beam 23. The photodetector 19 may measure the power of the reflected optical beam 23. The measured power may be converted to an electrical output signal 21. The electrical output signal 21 may be quantified in a measurement, such as voltage, and further analyzed. In one embodiment, a surface flaw may be indicated by a change in magnitude of reflected energy (which may also translate into one or more voltage measurements). The voltage measurements may be used in comparison with other voltage measurements. A measured voltage range may be analyzed in terms of a change in magnitude of reflected energy, for example, over a period of time. These voltage ranges may be measured, for example, across portions of the interior 37. An irregular surface, such as a surface flaw indicated by a crack, may scatter the projected optical beam 23. The result of which may include less laser or incoherent light returning to the probing device 15 and, hence, less power measured by the photodetector 19. Thus, by analyzing measured voltage ranges corresponding to the measured power of the reflected optical beam 23, it may be possible to ascertain the presence and location of surface flaws, such as cracks located within the threaded bore 25.

In another disclosed embodiment, the surface inspection device 4 may, alternatively, include the disclosed tool 10. As previously discussed, laser or incoherent light from the laser or incoherent light source 8 may be provided to the probe 26 of tool 10. Again, the probe 26 may function in the same capacity as the probing device 15. This may include emitting the laser or incoherent light as an optical beam 23 onto a surface of an object. In one disclosed embodiment, the optical beam 23 is emitted at approximately 90° from a surface of the probe 26 onto a surface of the object. The aforementioned surface of the object may include threads 27 of a threaded bore 25.

As in the previous embodiment, it is desirable to project the optical beam 23 directly into the root 33 of the threads 27 in order to increase the probability of detecting existing flaws on the surface of threads 27. This may require making an adjustment of the optical beam 23 with respect to the threads 27. Hence, it may be necessary to adjust a position of the probe 26 to align the optical beam 23 in the root 33 of the threads 27.

The probe end of the shaft 12 may be oriented to insert the probe 26 into a threaded bore 25 of a component. The threads 14 of tool 10 may be aligned with internal mating threads 27 of the bore 25. The drive unit 18 may be enabled to drive the shaft 12 to rotate the threads 14 into engagement with the mating internal threads 27 of the bore 25. As the threads 14 engage the internal threads 27 of the bore 25, the probe 26 may traverse a length of the bore. The aforementioned threaded engagement may facilitate alignment of the probe 26 for emitting laser or incoherent light as an optical beam 23 along targeted areas. This may ensure that the optical beam 23 covers all targeted areas for detecting potential flaws, such as in the root 33 of the threads 27.

The turning motion of the shaft 12 may guide the probe 26 down the threaded bore 25. The optical beam 23 emitted from the probe 26 (e.g., 90° from the side of the probe 26) may sweep down the bore 25 including a portion having internal threads 27. For example, the optical beam 23 may be swept down the root 33 of one or more internal threads 27 to inspect them for damage. As the optical beam 23 sweeps across an interior 37 surface of the threaded bore 25, an amount of laser or incoherent light may be reflected from an internal surface (e.g., the root 33 of internal threads 27) of the bore 25. The probe 26 may be configured to receive a reflectance of the optical beam 23 such as from the surface of the interior 37 of the threaded bore 25. In one disclosed embodiment, the reflected optical beam 23 may be transmitted from the probe 26 back to the beam splitter assembly 6. A photodetector 19 (e.g., coupled to the beam splitter assembly 6) may receive at least a portion of the reflected optical beam 23. The photodetector 19 may measure the power of the reflected optical beam 23. The measured power may be converted to an electrical output signal 21. The electrical output signal 21 may be quantified in a measurement, such as voltage, and further analyzed. Again, by analyzing measured voltage ranges corresponding to the measured power of the reflected optical beam 23, it may be possible to ascertain the presence and location of surface flaws, such as cracks located within the threaded bore 25.

As the probe 26 is inserted within the threaded bore 25, a top surface of the bore may come into contact with the lower spring pad 24. Continued rotation of the threads 14 into the threaded bore 25 may cause compression of the spring 22. Hence, an axial force may be generated along a length of the shaft 12 to produce a tight threaded engagement between the external threads 14 and the internal threads 27 of the bore. This may reduce any “play” or loose fit between mutual threads. The disclosed tight threaded engagement may facilitate alignment of the probe 26 within the bore 25 for performing inspection of the root 33 of the threads 27 and detecting any flaws. The disclosed axial tension may maintain the mutual threads in a consistent engagement so that the probe 26 can more accurately aim and maintain laser or incoherent light at a specific location, including, for example, the root 33 of a thread 27. Maintaining the mutual threads in the disclosed consistent engagement may also allow the probe 26 to more accurately receive a reflected amount of laser or incoherent light, such as, from an interior 37 surface of the bore 25.

It will be apparent to those skilled in the art that various modifications and variations can be made in the disclosed apparatus and method without departing from the scope of the disclosure. For example, additional or alternative structure may be provided to position the probe 26 relative to the threads 27 of the bore 25. This may include defining the threads 14 of shaft 12 to include any structure, such as a thread engagement member, that may be configured to physically contact the threads 27 of bore 25 in order to maintain a position of the probe 26. Hence, in one example, the tool 10 may include ball bearings configured to mate with the threads 27 of bore 25. In another example, the tool 10 may include one or more radially expandable devices received within threads 27 of bore 25 to maintain a position of the probe 26. Additionally, other embodiments of the apparatus and method will be apparent to those skilled in the art from consideration of the specification. For example, some described embodiments may be useful for inspecting additional surface structures of the bore 25 including, for example, interior regions 37 having non-threaded surfaces. In an embodiment wherein the surface inspection device 4 includes a CNC machine, the CNC machine may manipulate a position of the probing device 15 to be adjusted in directions, for example, along the X-axis, Y-axis, and Z-axis. Hence, in one disclosed embodiment, a position of the probing device 15 may be adjusted along a vertical axis of the interior 37 of the non-threaded portion of the bore 25. This may include sweeping the optical beam 23 emitted from the probing device 15 over the aforementioned non-threaded portion of the bore 25. The sweeping motion may include rotating the probing device 15 via the CNC machine such as along the Z-axis. It is intended that the specification and examples be considered as exemplary only, with a true scope of the disclosure being indicated by the following claims and their equivalents.

What is claimed is:

1. An apparatus for detecting flaws in a threaded bore having at least one thread with a helical root, the apparatus comprising:
a thread engagement member configured to engage the at least one thread of the threaded bore;
a probe coupled with the thread engagement member, the probe configured to direct light onto the helical root of the threaded bore, wherein the probe and the thread engagement member are adapted to rotate relative to the bore while the probe continually directs light onto the helical thread so that the light sweeps along a section of the helical root.

2. The apparatus of claim 1, wherein the probe is configured to receive reflected light.

3. The apparatus of claim 2, wherein the probe is configured to direct the reflected light to a photodetector.

4. The apparatus of claim 3, wherein the probe is configured to direct the reflected light to a beam splitter device prior to the photodetector.

5. The apparatus of claim 1, wherein the probe is configured to focus the light at a point onto the helical root of the threaded bore.

6. The apparatus of claim 1, wherein the probe is configured to direct the light at 90° from a longitudinal axis of the probe onto the helical root of the threaded bore.

7. The apparatus of claim 1, further including an alignment member for producing a biasing force between the thread engagement member and the at least one thread in order to increase the tightness of the engagement between the thread engagement member and the at least one thread.

8. The apparatus of claim 7, wherein the alignment member maintains a position of the probe with respect to the at least one thread.

9. The apparatus of claim 7, wherein the alignment member includes a spring.

10. The apparatus of claim 1, wherein the threaded engagement member includes one of at least one corresponding thread, ball bearings, and a radially expandable device.

11. A method for detecting flaws in a threaded bore having at least one thread with a helical root, the method comprising:
directing light onto a point on the helical root;
moving the point along the length of a section of the helical root;
receiving back a reflectance of the light; and
determining whether a flaw is present based, at least, in part upon the reflected light.

12. The method of claim 11, wherein the moving step includes rotating the point relative to the bore while continually directing light onto the helical root so that the light sweeps along a section of the helical root.

13. The method of claim 11, further including directing the received reflected light to a photodetector.

14. The method of claim 11, further including focusing the light at the point on the helical root.

15. The method of claim 11, further including positioning the light based upon a location of the at least one thread.

16. The method of claim 11, wherein the directing step includes engaging the at least one thread to align the light onto a point on the helical root.

17. The method of claim 16, wherein the engaging step includes a threaded engagement.

18. The method of claim 16, further including applying an axial force along the at least one thread to produce a tight threaded engagement.

19. The method of claim 11, wherein the directing step includes directing light along a longitudinal axis within the bore and projecting the light at 90° from the longitudinal axis onto the point on the helical root.

20. The method of claim 11, wherein the determining step includes measuring the power of the received reflected light.
